(19) United States
(12) Patent Application Publication
(10) Pub. No.: US 2004/0166276 A1
(43) Pub. Date: Aug. 26, 2004

(54) Promotional article, such as for advertising, product sampling or information supplying, and method of manufacturing same

(75) Inventors: Xavier De La Motte-Bouloumie, Vichy (FR); Gerard Collard, Le Vernet (FR)

Correspondence Address: HOFFMANN & BARON, LLP, 6900 JERICHO TURNPIKE, SYOSSET, NY, 11791, US

(73) Assignee: WALLON IMPRIMEUR SA.

(21) Appl. No.: 10/702,803

(22) Filed: Nov. 5, 2003

Related U.S. Application Data
(63) Continuation-in-part of application No. PCT/FR02/01526, filed on May 3, 2002.

(30) Foreign Application Priority Data
May 7, 2001 (FR) FR 01/06212

(51) Int. Cl. B32B 9/00

(52) U.S. Cl. 428/40.2; 428/40.1; 428/43

(57) ABSTRACT

A promotional article, such as for advertising, product sampling or information supplying, includes a support substrate having a substantially flat housing formed thereon and a strip substantially enclosed within the housing. The housing is formed by folding over a flap portion of the support substrate. The strip has a fixing portion and a tongue portion, wherein the tongue portion is at least partially detachable from the fixing portion and the fixing portion is fixed to an inner surface of the housing. Thus, the tongue portion of the strip can be at least partially removed from within the housing by pulling the tongue portion from the fixing portion. A method for manufacturing a promotional article according to the present invention generally includes the steps of forming a fixing portion and a tongue portion on a strip, fixing the fixing portion of the strip to a flat surface of a substrate and forming a substantially flat housing by folding a flap portion of the substrate over the strip to substantially enclose the strip. The tongue portion of the strip is at least partially detachable from the fixing portion and can be at least partially removed from within the housing by pulling the tongue portion from the fixing portion.

### CROSS-REFERENCE TO RELATED APPLICATIONS

This application is a continuation-in-part of PCT/FR02/01526, filed on May 3, 2002, which claims priority to FR 01/06212, filed on May 7, 2001.

### FIELD OF THE INVENTION

The present invention concerns the technical sector of products for use as an advertising medium, information, sampling or other, comprising means with an advertising, information, sampling or other function adapted to be moved or “disconnected” wholly or partially from their housing by pulling. Such products are particularly intended to be inserted or glued in journals, magazines, brochures and in general terms in any article which can be produced from paper, cardboard, plastic etc on cutting, folding etc machines used in printing.

### BACKGROUND OF THE INVENTION

The patent EP 0 297 959 (FIGS. 1 and 4) is known, which describes an article in the shape of a perfume bottle, comprising a removable tongue 2 housed in a substantially flat case 3. The tongue 2 has an emerging part 7 in the shape of a stopper, and another part housed in the case. This is clad with an adhesive film 11 comprising fragrance microcapsules 12, which are destroyed during the pulling by abrasive particles present on one of the faces 3 of the film 11. The fragrance is released when a user extracts the tongue 2 from its case.

The patent CA 2 105 194 (FIG. 2) describes an element 10 in the shape of a perfume bottle, formed by two pieces back to back, fixed or connected to each other, and comprising a strip 11 having a layer 12 of fragrance on at least one of its faces.

These last two documents present articles in the shape of a perfume bottle without describing the method of manufacturing such products. It was not technically possible to manufacture such products on an industrial scale at the time of filing of these applications, which must therefore be considered as expressing intellectual ideas and without any usable technical teaching.

This is because the physical configuration of machines did not make it possible to move machine components within the same manufacturing line, and the glues and aqueous solutions comprising fragrance microcapsules were of lower performance.

There is therefore a significant recognized need for creating a product comprising a means which can be moved, slid or disconnected from a support by a simple pull, whilst being manufactured on an industrial scale easily and economically.

### SUMMARY OF THE INVENTION

The present invention concerns a method of manufacturing an article to be inserted in magazines, brochures, books and the like, and in general terms comprising a housing containing means with an advertising, sampling, information or similar function, which are moved, slid, separated and possibly wholly or partly removed from their housing by the use of a pull. The present invention also concerns the article thus manufactured and the industrial product comprising such an article.

A method of manufacturing a promotional article, such as for advertising, product sampling or information supplying, according to the present invention, generally includes the steps of forming a fixing portion and a tongue portion on a strip, fixing the fixing portion of the strip to a flat surface of a substrate and forming a substantially flat housing by folding a flap portion of the substrate over the strip to substantially enclose the strip. The tongue portion of the strip is at least partially detachable from the fixing portion and can be at least partially removed from within the housing by pulling the tongue portion from the fixing portion.

In a preferred embodiment, the method further includes the step of initially cutting off a portion of the substrate to form the strip wherein the strip is preferably substantially rectangular. Also, the fixing portion of the strip is preferably glued to the flat surface of the substrate during the fixing step. Preferably, the method further includes the step of forming a perforation in the strip between the fixing portion and the tongue portion, wherein the perforation allows the tongue portion to be at least partially detachable from the fixing portion and the tongue portion of the strip can be at least partially removed from within the housing by pulling the tongue portion in a longitudinal direction.

In one embodiment of the present invention, the method further includes the step of applying a fragrance to at least a portion of the strip tongue portion. The fragrance may be applied to the tongue portion by a microencapsulation process. Additionally, the fragrance may be applied to an inner surface of the housing formed by the substrate.

In another embodiment, the strip is formed with two tongue portions on opposite sides of the fixing portion, wherein the two tongue portions can be at least partially removed from within opposite ends of the housing by pulling the tongue portions from the fixing portion.

The step of forming the substantially flat housing may further include the step of adhering the flap portion to the substrate after folding the flap portion. Also, the method may further include the step of folding a second flap portion of the substrate over the housing to cover the housing with the second flap portion. The method may further include the step of cutting out at least one lateral part of the substrate, wherein the lateral part provides access to the tongue portion within the housing. Preferably, the lateral part has a shape selected from the group consisting of a circle, a square, a hexagon, a semi-circle, a heart, a club and a spade.

The method according to the present invention may further include the step of applying a barrier material to an inner surface of the housing formed by the substrate. The barrier material may substantially enclose the strip when the housing is formed.

In another embodiment of the present invention, at least a portion of the strip tongue portion may be positioned to extend outwardly from the housing and the method may include the step of cutting the housing and the portion of the strip tongue portion extending outwardly from the housing to a desired shape. One such shape may be that of a perfume bottle and the portion of the strip tongue portion extending outwardly from the housing is cut in the shape of a perfume bottle stopper.

In yet another embodiment of the present invention, the method may further include the step of cutting a desired shape into the folded substantially flat housing. Preferably, the shape is cut into the housing by perforating the housing, wherein the shape forms an integral part of the housing, but can be detachable therefrom. The shape has a grip portion and a body portion, wherein the grip portion is separable from the body portion for at least partially removing the tongue portion of the strip from within the body portion. The grip portion of the housing is preferably connected to the tongue portion of the strip so that the grip portion is used to pull the tongue portion of the strip out of the body portion of the housing. The body portion of the shape can be cut in the shape of a perfume bottle and the grip portion of the shape can be cut in the shape of a perfume bottle stopper.

The promotional article, such as for advertising, product sampling or information supplying, according to the present invention, generally includes a support substrate having a substantially flat housing formed thereon by folding over a flap portion of the support substrate and a strip substantially enclosed within the housing. The strip has a fixing portion and a tongue portion, which is at least partially detachable from the fixing portion, and the fixing portion is fixed to an inner surface of the housing. The tongue portion of the strip can be at least partially removed from within the housing by pulling the tongue portion from the fixing portion.

In a preferred embodiment, the strip is substantially rectangular and is formed by initially cutting off a portion of the support substrate. Also, the fixing portion of the strip is preferably glued to the inner surface of the housing. The strip also preferably includes a perforation between the fixing portion and the tongue portion, wherein the perforation allows the tongue portion to be at least partially detachable from the fixing portion. The tongue portion of the strip can also be at least partially removed from within the housing by pulling the tongue portion in a longitudinal direction.

As mentioned above, in one embodiment of the present invention, the tongue portion of the strip includes a fragrance applied thereon by microencapsulation. Alternatively, or in addition to, the inner surface of the housing may include a fragrance applied thereon. Also as mentioned above, the article may take the form of a perfume bottle and a portion of the strip tongue portion may extend outwardly from the housing and take the shape of a perfume bottle stopper.

In an alternative embodiment, the promotional article generally includes a substantially flat housing having an interior pocket defined therein and a strip substantially enclosed within the pocket of the housing. The strip has a fixing portion and a tongue portion. The tongue portion is at least partially detachable from the fixing portion and the fixing portion is fixed to an inner surface of the housing pocket. In this manner, the tongue portion of the strip can be at least partially removed from the pocket within the housing by pulling the tongue portion from the fixing portion.

In a preferred alternative embodiment, the substantially flat housing is made from a substrate folded over upon itself to substantially enclose the strip. Also, the strip preferably includes a perforation between the fixing portion and the tongue portion for allowing the tongue portion to be at least partially detachable from the fixing portion. As mentioned above, the tongue portion of the strip also preferably includes a fragrance applied thereon.

At least a portion of the strip may extend outwardly from the housing and take the form of a perfume bottle stopper, wherein the housing itself takes the form of a perfume bottle. Alternatively, the housing may be formed having a grip portion and a body portion, wherein the body portion defines the interior pocket therein. In this case, the grip portion, which is preferably connected to the tongue portion of the strip, is separable from the body portion for at least partially removing the tongue portion of the strip from the body portion pocket. Moreover, the body portion may have the shape of a perfume bottle and the grip portion may have the shape of a perfume bottle stopper.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIGS. 1 to 13 relate to the first embodiment according to the invention, whilst FIGS. 14 to 25 relate to the second embodiment according to the invention and FIGS. 26 to 32 relate to the third embodiment according to the invention.

FIG. 1 depicts a flat surface 1 provided with a strip 20 to be cut.

FIG. 2 depicts the cutting of the lateral parts 5 in the form of thumb indexes on the sides cd and cg of the said surface.

FIGS. 2 to 13 describe the treatment of the strips 20 and 21 so as to obtain an article with a housing enclosing two perfumed tongues.

FIG. 3 depicts the cutting of the strip 20.

FIG. 4, composed of FIGS. 4a and 4b, depicts the cutting of the tongues 4 on the strip 20.

FIG. 5 depicts the gluing of the area 70 on the strip 21.

FIGS. 6 and 7 illustrate the superimposing of the strips 20 and 21.

FIG. 8, composed of FIGS. 8a and 8b (FIG. 8b being a side view of FIG. 8a), depicts the fixing of the strip 20 to the strip 21.

FIG. 9, composed of FIGS. 9a and 9b (FIG. 9b being a side view of FIG. 9a), describes the step of coating perfume on the tongues 4 and on the flap 3.

FIG. 10 illustrates the depositing of glue on a part 71 of the strip 21.

FIG. 11, composed of FIGS. 11a and 11b (FIG. 11b being a side view of FIG. 11), shows the folding of the flap 3 over the strip 20, so as to create a housing 9.

FIG. 12 presents the strip 21 provided with the housing 9/flap 3 enclosing two tongues 4.

FIG. 13 depicts the final step of folding of the strip 21 into two superimposable parts.

FIGS. 14 to 25 illustrate the second embodiment according to the invention, namely that:

FIG. 14 depicts a flat surface 1 provided with a strip 20 to be cut.

FIG. 15 illustrates the lamination of the external face of the strip 21.

FIG. 16 depicts the strip 20 and the strip 21 laminated after cutting.

FIG. 17, composed of FIGS. 17a and 17b, illustrates respectively the steps of gluing and folding the strip 20.

FIG. 18, composed of FIGS. 18a and 18b (FIG. 18b being a side view of FIG. 18a), depicts the superimposing of the strip 20 on the internal part of the laminated strip 21.

FIG. 19 depicts simultaneously the steps of gluing and folding the strip 20 and superimposition on the internal part of the laminated strip 21.

FIG. 20, composed of FIGS. 20a and 20b (FIG. 20b being a side view of FIG. 20a), depicts the strip 20 and the strip 21 laminated after folding and gluing of the strip 20 and superimposition of the two strips in an offset manner.

FIG. 21, composed of FIGS. 21a and 21b (FIG. 21b being a plan view of FIG. 21a), illustrates the step of cutting a tongue 4 on part of the strip 20.

FIG. 22, composed of FIGS. 22a and 22b (FIG. 22b being a side view of FIG. 22a), depicts the fragrance coating on the tongue 4.

FIG. 23, composed of FIGS. 23a to 23c (FIG. 23c being a side view of FIG. 23b, in transverse section along the axis x), depicts the gluing 70 of the strip 20 and the fixing of the strips to each other.

FIG. 24 depicts the folding of the flap 3 over the strip 20, so as to create a housing 9.

FIG. 25, composed of FIGS. 25a to 25c, depicts the article obtained according to the second embodiment, FIG. 25c being a side view of FIG. 25b.

FIGS. 26 to 32 illustrate the third embodiment according to the invention, namely that:

FIG. 26 depicts a flat sheet provided with a strip 20 to be cut.

FIG. 27 illustrates placement of the cut strip 20 on the flat sheet. FIG. 28 depicts application of a fragrance 506 on the tongue 4 of the strip 20.

FIG. 29 shows the application of an adhesive 507 on the opposite half of the sheet.

FIG. 30 shows the folding over of the sheet.

FIG. 31 depicts the forming of a shape 509 on the folded sheet.

FIG. 32 shows the shape 509 removed from the sheet and the perfumed tongue 4 of the strip being removed from the shape.

### DETAILED DESCRIPTION OF THE PREFERRED EMBODIMENTS

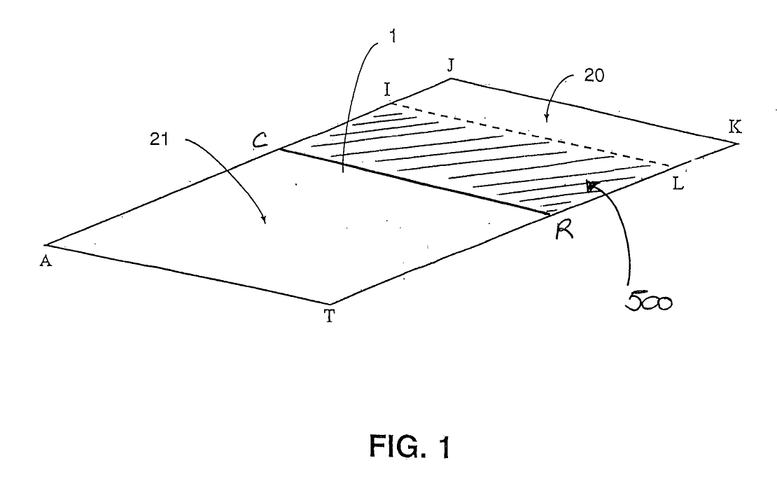

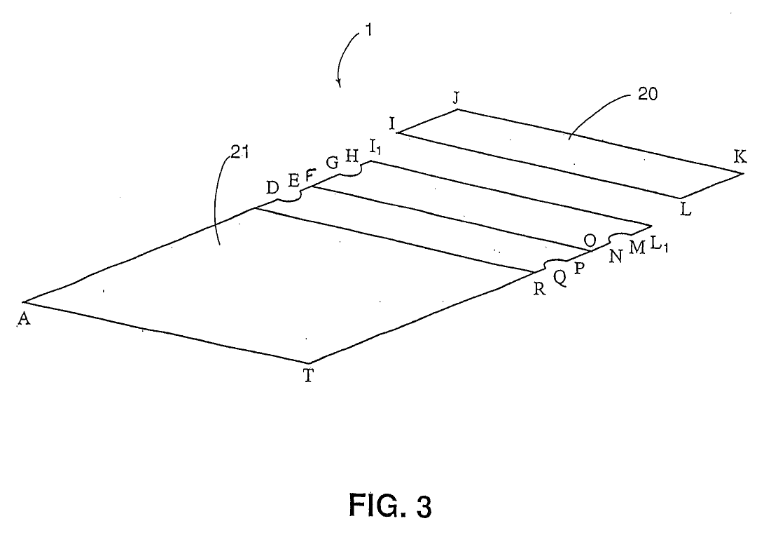

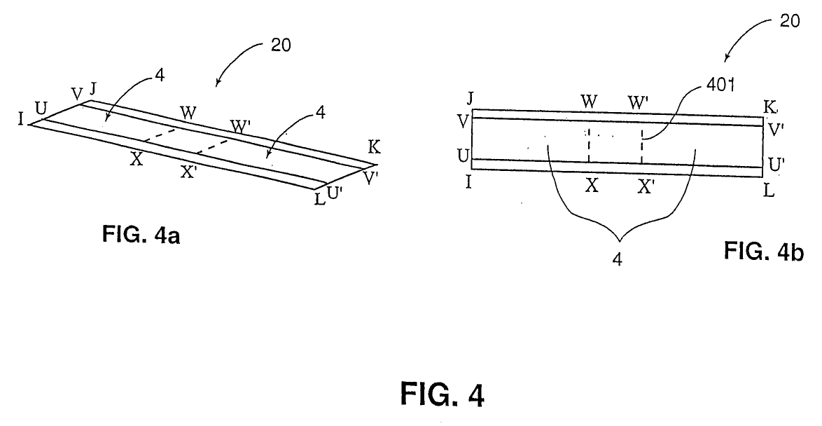

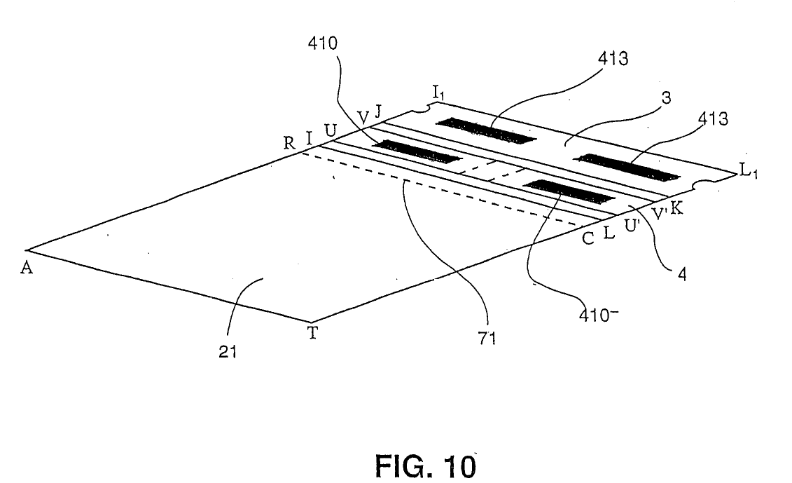

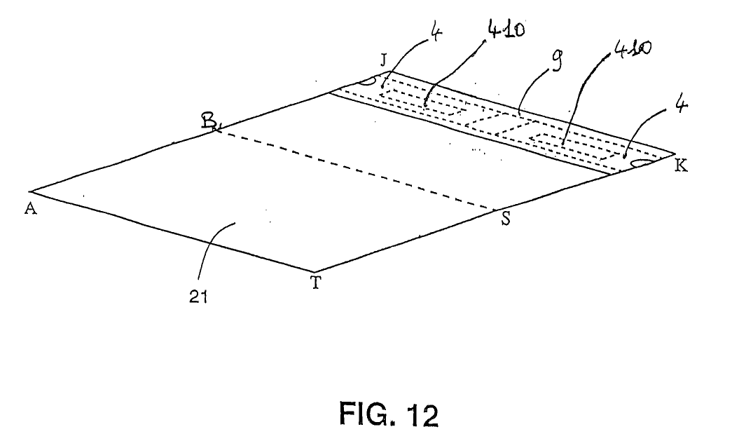

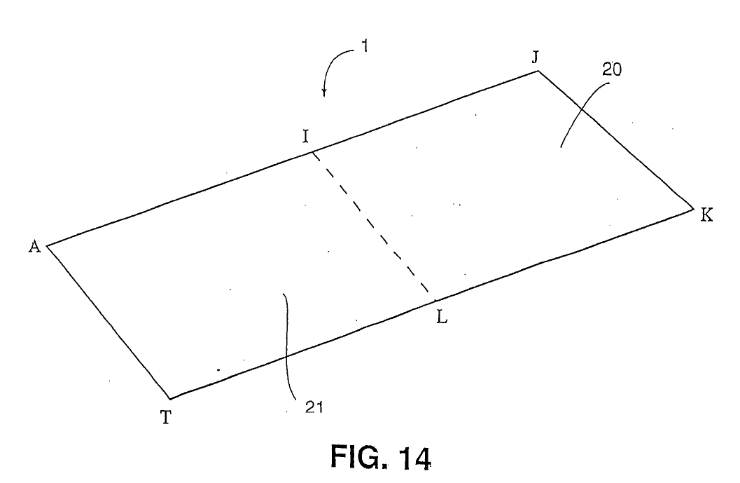

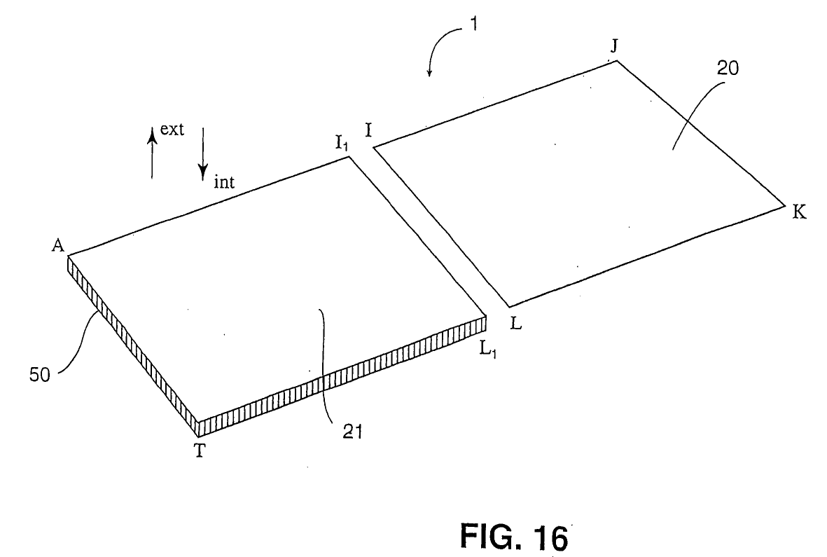

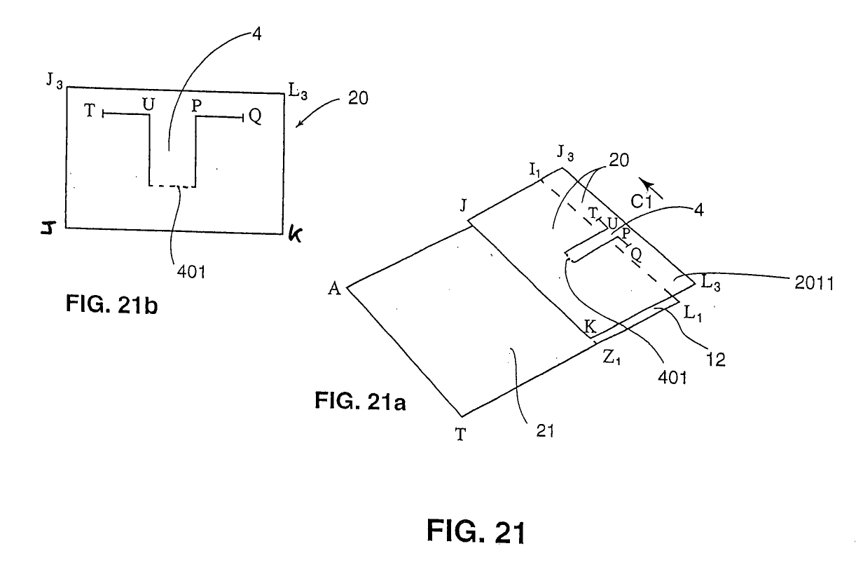

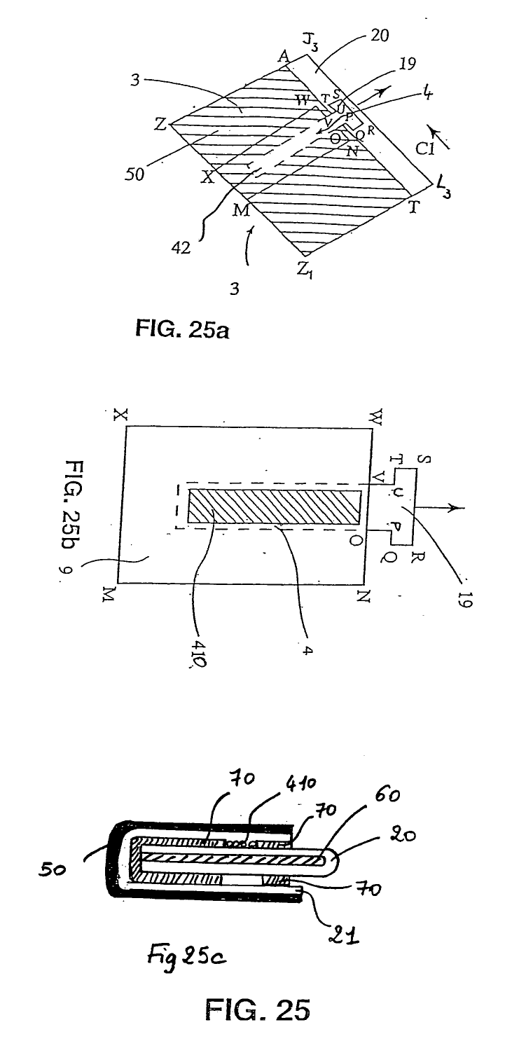

The invention concerns a method of manufacturing, from a flat surface 1 (FIGS. 1 and 14), at least one article (FIGS. 12, 25b) comprising at least one substantially flat housing 9 (FIGS. 12, 25b) intended to enclose a strip 20 (FIGS. 3, 16) provided with at least one means 4 (FIGS. 4 and 21) with an advertising, information, sampling or other function, the means 4 being adapted to be completely or partially “disconnected” from the said housing 9 formed by the flap 3 (FIGS. 10, 11, 23, 24), by a pull, the said manufacturing method being characterized in that it comprises the steps of:

A) cutting (FIGS. 3 and 16) an end part 20 of the flat surface 1, so as to form firstly a substantially rectangular strip 20 irreversibly detached from the flat surface 1, and secondly a strip 21; and

B) treating (FIGS. 4 to 13, FIG. 15 and FIGS. 17 to 25) the strips 20 and 21 by a succession of folding, superimposition, cutting and gluing steps adapted to create at least one housing 9 intended to enclose a strip 2 provided with at least one means 4 which can be disconnected completely or partially from the said housing by means of a pull.

“Enclosing” means here the fact that the means 4 is stuck by dots of glue to the housing 9 or fixed or attached by attachment or weak points which are created by cutting out the contour of the said means 4 in an interrupted fashion. The means 4 can partly project from or not project from the housing 9. Possibly the means 4 may not be fixed, and be held solely by friction in the housing 9.

“Disconnect” means here the fact that the means 4 is moved, slid or otherwise extracted from the housing 9 by means of a pull, so as to obtain firstly the means 4 alone and secondly the housing 9 without the said means 4. This also means that, when pulling takes place, the dots of glue for sticking the means to the housing come unstuck or the attachment or weak points tear. The case is also covered where the means 4 is only partially “disconnected” from the support. A case is also covered where the means 4 can slide in both directions out of, and towards, its housing (the case of a multiple-use tongue, for example an advertising surface without fragrance).

“Discontinuous” means that the cut is made in an interrupted fashion, which creates breaks in cuts. These breaks correspond to the attachment or weak points which tear.

Description of treatment step B)

First Embodiment According to the Invention.

In the first embodiment according to the invention, the treatment comprises the following steps (FIGS. 4 to 13):

cutting at least one strip forming a means 4 (FIG. 4) with an advertising, information, sampling or other function, over at least part of the strip 20, the said strip being rectangular or substantially rectangular,

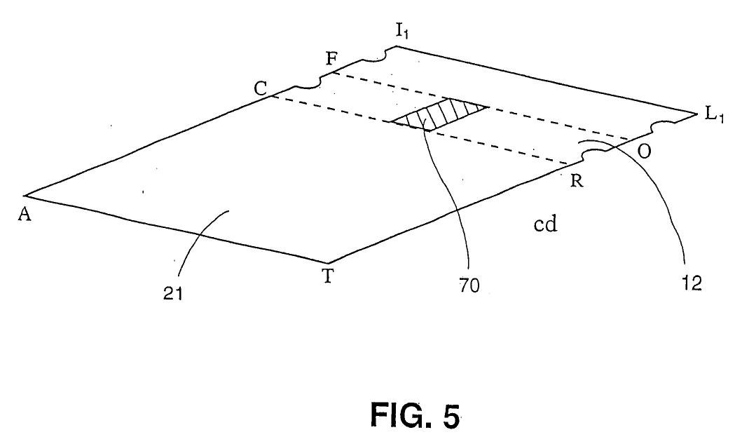

gluing (FIG. 5) an area 70 of the said internal part 12 of the strip 21,

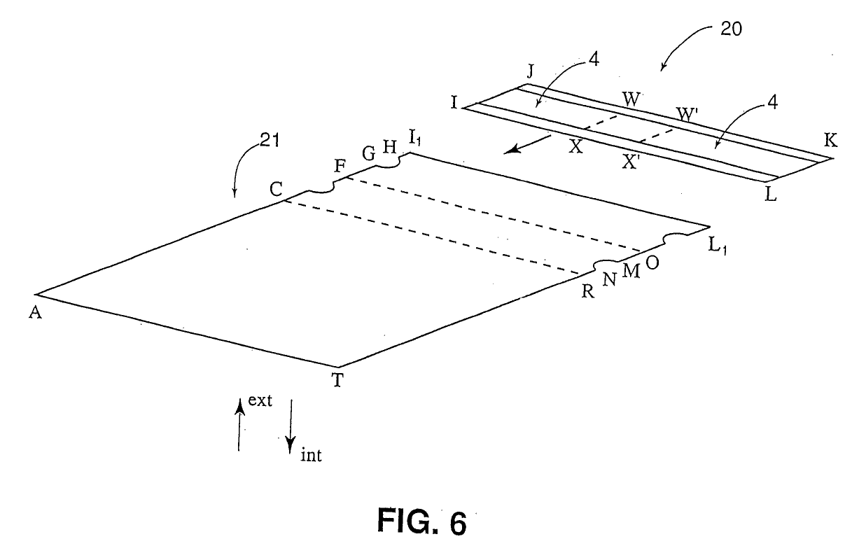

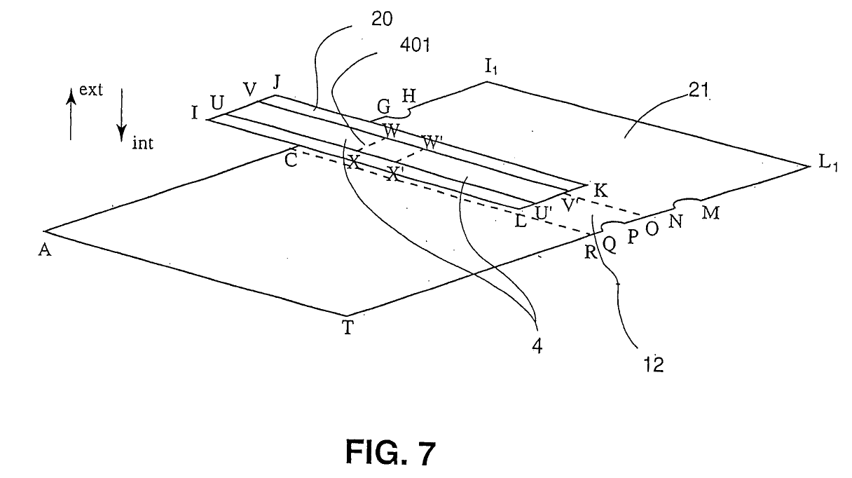

total or partial superimposition (FIGS. 6 and 7) of the substantially rectangular strip 20 on at least one internal part 12 of the strip 20 previously glued as above,

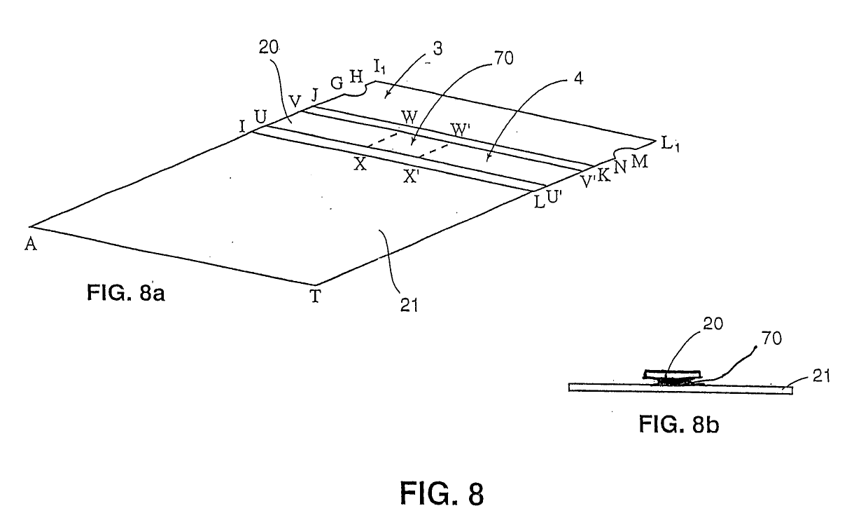

fixing (FIG. 8) the strip 20 to the strip 21 at the area 70, the fixing being adapted to leave an end strip, which will form a flap 3 integral with the strip 21,

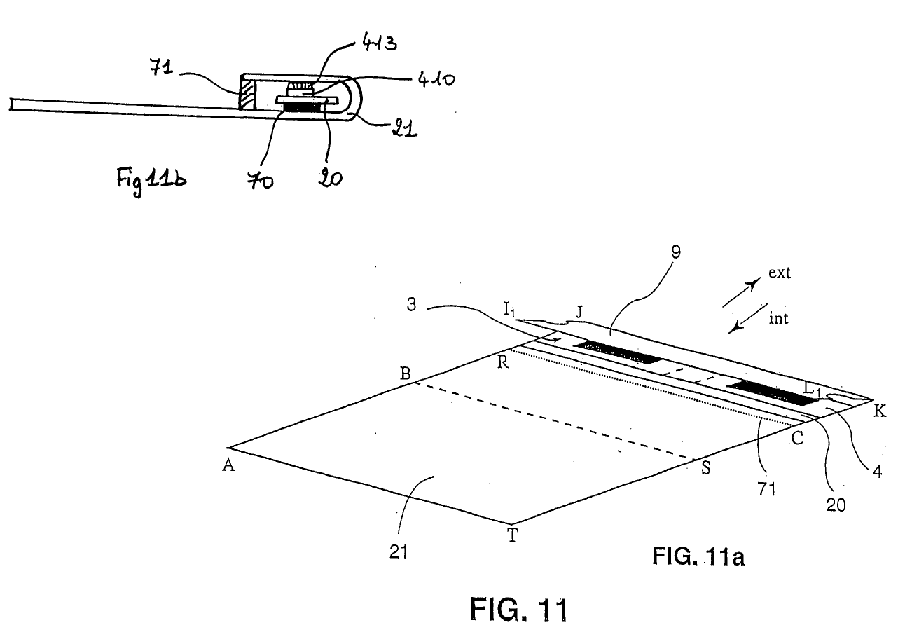

folding (FIG. 11) the flap 3 over the said strip 20 so as to create at least one substantially flat housing 9 intended to enclose the said strip 20 provided with at least one means 4.

The cutting of at least one means 4 is preferably “discontinuous” (FIG. 4b), so as to create at least one attachment point 401 along the contour of the means 4, enabling this means to be connected to the strip 20.

The means 4 is preferably cut so that the pull necessary for the complete or partial disconnection of the means out of its housing 9 is made in the cutting direction of the strip 20.

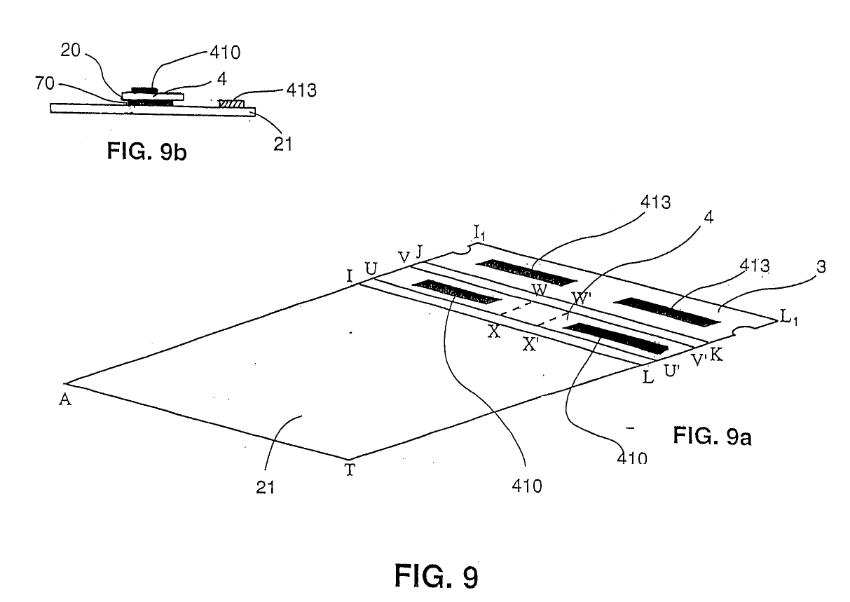

The treatment of the strips 20 and 21 preferably also comprises a step of coating (FIG. 9) at least one fragrance on at least one part 410 of at least one means 4 and/or on at least one part 413 of the flap 3.

The coating step preferably takes place after the said step (FIG. 8) of fixing the strip 20 to the strip 21 at the area 70.

The method according to the invention preferably comprises the coating of a fragrance on two parts 410 of two means 4 and on two parts 413 of the flap 3.

The treatment also comprises a step of depositing an adhesive means (FIG. 10) on at least part 71 (CR or I1L1) of the strip 21. This depositing is intended to fix the flap 3/housing 9 to the strip 21. It is preferably carried out before the flap 3 is folded over the strip 20.

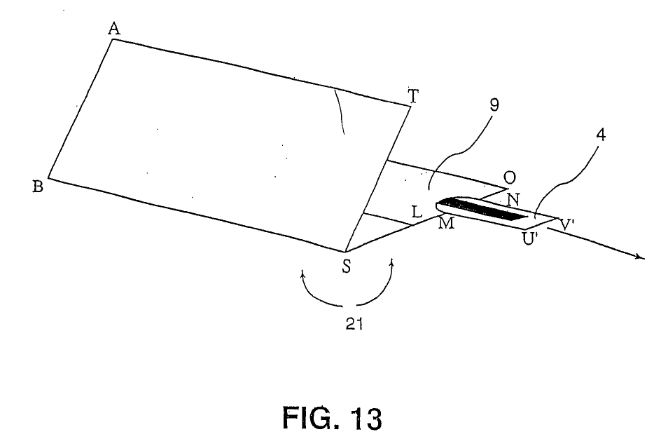

In a particular embodiment, the method according to the invention also comprises the step (FIG. 13) of folding the strip 21 carrying the housing 9 in two superimposable parts, so as to conceal the housing by means of one of the said parts. The step of folding the strip 21 is carried out after the treatment of the strips 20 and 21.

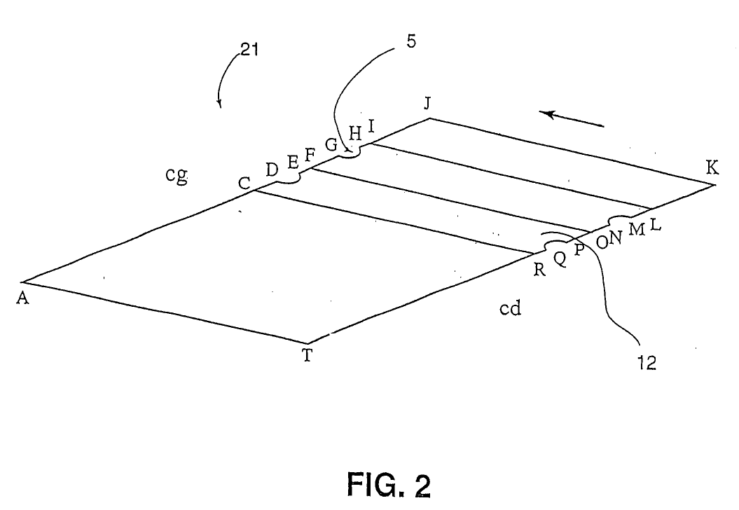

In a particular manner, the method according to the invention also comprises a cutting (FIG. 2) of at least a lateral part 5 (DE, GH, QP, NM) on at least one side cd and/or cg of the flat surface 1, the said side being perpendicular to the side carrying the flap 3. The function of the lateral parts 5 is to facilitate the gripping of the means 4 in its housing 9, during the pull necessary for the complete or partial disconnection of the said means out of its housing 9. The pull is carried out perpendicular to one or other or both of the sides cd and cg.

The cutting of at least one lateral part 5 is preferably carried out before the cutting of an end part 20 of the flat surface 1.

The lateral parts 5 have various shapes, such as round, square, hexagonal or semicircular, or in the shape of symbols such as a heart, club or spade, or the shape of a perfume bottle, the shape of the said parts depending on the choice and wishes of the customer.

The method according to the invention preferably implements the cutting of two lateral parts on each side cd and cg, each part being in the form of a thumb index (semicircular).

The housing 9 (FIG. 12) preferably encloses a strip 20 provided with two tongues 4 perfumed 410 by microencapsulation.

In a particular embodiment, the method according to the invention also comprises a step of depositing a material forming a barrier 500 on at least a part ICRL of the flat surface 1.

This step is preferably carried out before the step of cutting the end part 20 of the flat surface 1, and even more preferably before the step of cutting at least one lateral part 5.

Second Embodiment According to the Invention:

In a second embodiment according to the invention, the treatment of the strips 20 and 21 also comprises the steps of:

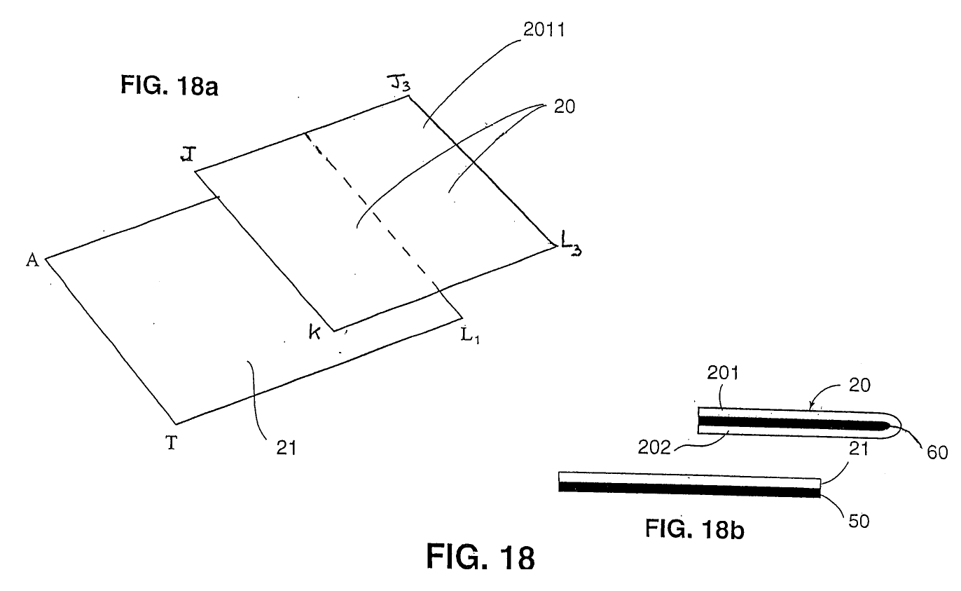

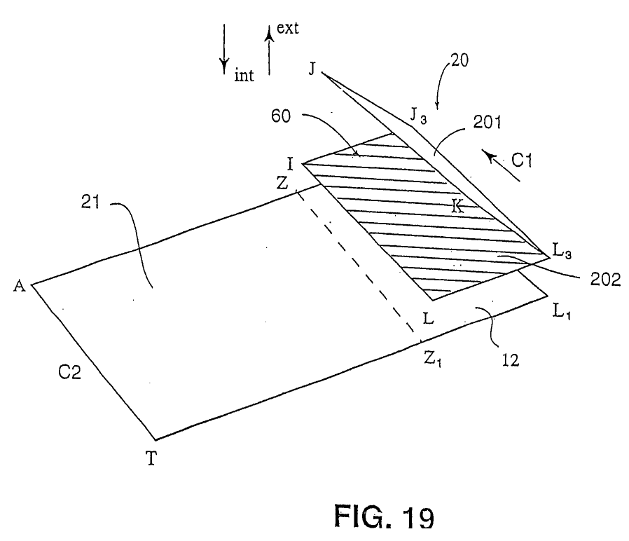

complete or partial superimposition (FIGS. 18 and 19) of the substantially rectangular strip 20 on at least one internal part 12 of the strip 21,

cutting (FIG. 21) at least one strip forming a means 4 with an advertising, information, sampling or other function, on at least one part of the strip 20, the said strip being rectangular or substantially rectangular,

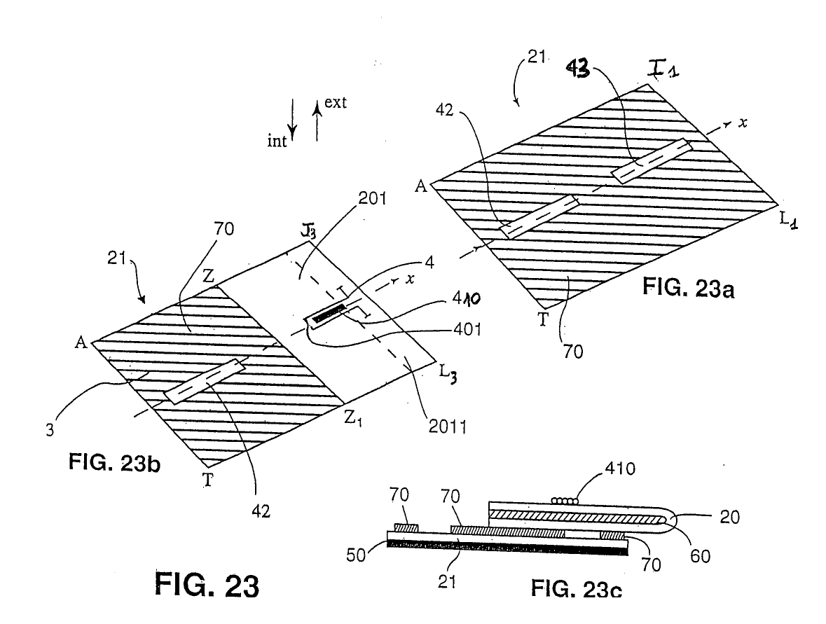

gluing (FIG. 23a) an area 70 of the strip 21, and then fixing (FIG. 23b) the strip 20 to the strip 21 at this area 70, the fixing being adapted to form a flap 3 integral with the strip 21, and

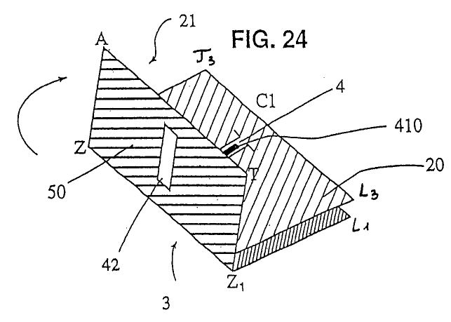

folding (FIG. 24) the flap 3 over the strip 20 so as to create at least one substantially flat housing 9 containing the said strip 20 provided with at least one means 4.

The cutting of at least one means 4 is preferably “discontinuous” (FIG. 21), so as to create at least one attachment point 401 along the contour of the means 4, enabling this means to be connected to the strip 20.

The means 4 is preferably cut so that the pull necessary for the complete or partial disconnection of the means out of its housing 9 is carried out in the direction c1 perpendicular to the direction of cutting of the strip 20.

The step (FIGS. 23b and 23c) of fixing the strips 20 and 21 at the area 20 is adapted so that part 2011 of the strip 20 projects out of one edge c1 of the strip 21 and this projecting part 2011 partly comprises the means 4. Because of this, part of the means 4 will not be fixed to the said strip 21.

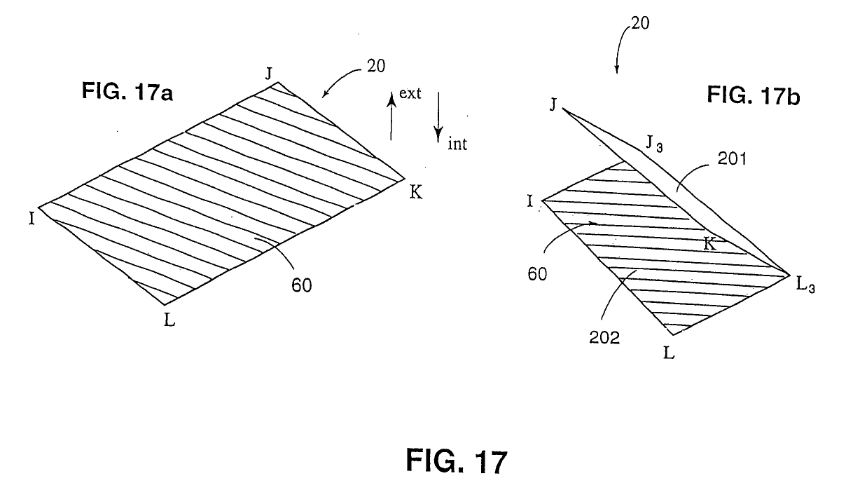

In a particular embodiment, the treatment also comprises the gluing 60 (FIG. 17a) of at least one of the internal parts 201, 202 of the strip 20, and then the folding (FIG. 17b) of the strip 20 in two parts 201, 202, superimposable at any point, and of the said parts 201, 202. The folding and gluing make it possible to fix the parts 201, 202 together on each other and thus to form a strip 20 folded in two.

The gluing and folding are preferably carried out after the cutting of the end part 20 and before the step of superimposing the strip 20, and even more preferably the gluing, folding and superimposition steps are carried out simultaneously (see FIG. 19).

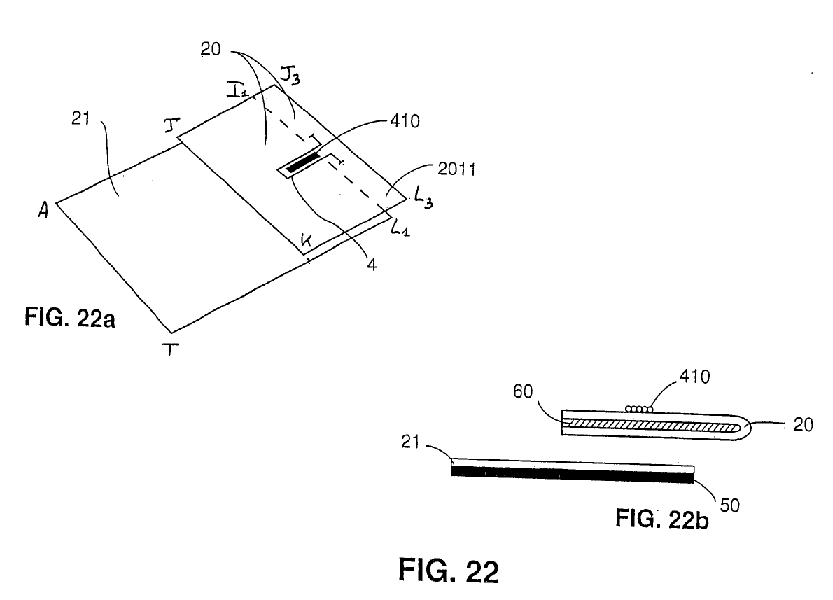

In a preferred embodiment, the treatment of the strips 20 and 21 also comprises a step of coating (FIG. 22) at least one fragrance on at least one part 410 of at least one means 4.

This coating step is preferably carried out after the cutting (FIG. 21) of at least one means 4 and before the gluing (FIG. 23a) of an area 70 of the strip 21.

The treatment preferably also comprises a cutting (FIG. 25a) of the contour of the housing 9 and of the contour of the means 4 partly projecting 19 out of the housing 9. This cutting is implemented after the folding (FIG. 24) of the flap 3 and makes it possible to obtain an article (FIG. 25b) comprising a housing 9 enclosing a strip 20 provided with at least one means 4 with an advertising, sampling or other function. This means is adapted to be completely or partially disconnected from its housing 9/flap 3 by means of a pull exerted in the direction of cutting of the end strip 20.

Even more preferably, the cutting is adapted so that the housing 9 has the shape of a perfume bottle, the cut creating a stopper 19 (FIG. 25b) integral with the means 4. The stopper corresponds to the part projecting out of the housing. It is in fact produced by the superimposition and fixing of the strip 20 outside the edge c1 of the strip 21 and then folding of the flap 3 over the strip 21.

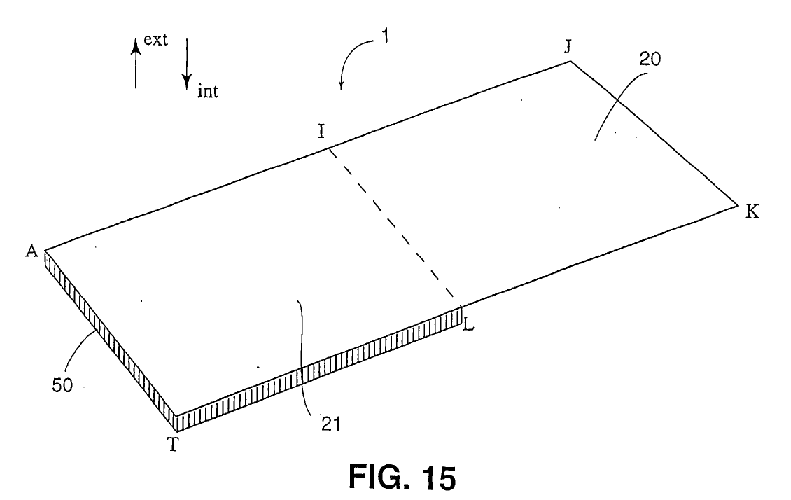

The treatment of the strips 20 and 21 preferably also comprises the lamination 50 (FIG. 15) of at least one of the faces of the strip 21 (ATIL). The lamination is preferably carried out before the step of cutting (FIG. 16) the end part 20 and preferably on the external face of the strip 21.

The pull enabling the means 4 to be “disconnected” completely or partially from its housing is preferably carried out by the hand of the user.

The means 4 is preferably a tongue attached to the strip 20 and contained in the flap 3/housing 9 (FIG. 25b).

Preferably said means 4 is a perfumed tongue and even more preferably a perfumed tongue comprising an application of perfume and a protection against evaporation or a perfumed tongue comprising an area sampled by microencapsulation.

The means 4 is preferably a tongue comprising information such as for example medical information or information for example about marital status or addresses, telephone numbers, information of this type on a sticker placed on the means 4, information means for scratching comprising for example inscriptions of the type “winning” or “losing” for an advertising game and the like, or comprising thermochromic pigments.

In a preferred embodiment, the flat surface 1 (FIGS. 1 and 14) is a paper, cardboard or synthetic medium.

The invention also concerns the article formed from a flat surface 1 cut into a substantially rectangular end strip 20 irreversibly detached from the flat surface 1, and a strip 21, said article comprising at least one substantially flat housing 9 comprising a strip 20 provided with at least one means 4 with an advertising, information, sampling or other function, adapted to be completely or partially “disconnected” from the said housing 9 formed by a flap 3 integral with the strip 21, by means of a pull.

The article (FIGS. 12, 13 and 25b) is obtained by the manufacturing method according to the invention.

According to the first embodiment, the substantially flat housing 9 (FIG. 12) is situated on and at the edge of the flat surface 1.

According to another embodiment according to the invention, the means 4 comprises information such as for example medical information or information for example on marital status or addresses, telephone numbers, information on a sticker placed on the means 4, information means for scratching comprising for example inscriptions of the “winning” or “losing” type for an advertising game and the like, or comprising thermochromic pigments.

According to another embodiment according to the invention, the pull for completely or partially “disconnecting” the means 4 from its housing is exerted by the hand of the user.

The invention also concerns the industrial product which comprises at least one article according to the invention. This industrial product is chosen from the group formed by inserts, journals, brochures, magazines, newspapers, books, postcards, greetings cards, mailings or personalized letters and the like, the medical sheets comprising medical information, and the informative sheets comprising information for example on marital status, addresses, telephone numbers and information of this type on a sticker placed on the means 4, information means for scratching comprising for example inscriptions of the type “winning” or “losing”, or a means 4 comprising thermochromic pigments.

Further Description of the First Embodiment:

FIG. 1 presents the flat surface 1 from which the article according to the invention will be manufactured. The surface 1 is a paper support, which has an end part IJKL, which will subsequently be cut.

The surface 1 preferably undergoes a color and text printing step (for example the printing of a background color of the surface 1 and of an advertising text). A printed surface 1 is obtained. This printing step is a normal step known to persons skilled in the art.

It is followed by a step of depositing a material forming a barrier 500 on a part ICRL of the flat surface, close to the end part (IJKL) or strip 20 which will subsequently be cut. This step of depositing material is preferably carried out before the cutting of thumb indexes (DE, GH) on the flat surface 1.

Preferably, this part ICRL comprising a material forming a barrier 500 makes it possible on the one hand to reinforce the protection of the tongues which will subsequently be formed, and on the other hand to prevent the evaporation of the fragrance to be deposited subsequently on the printed surface 1 to be treated, in the case where it is wished to manufacture an article according to the invention provided with perfumed tongues. For reasons of clarity, the material forming a barrier 500 will not appear in the following figures.

The material forming a barrier 500 is chosen from amongst a lacquer, a sheet of the plastic type, such as polypropylene, or of the metal type such as aluminum, or of a multilayer material (for example a lacquer+a plastic or metallic sheet, or a combination of these three elements).

FIG. 2 describes the cutting of two thumb indexes (DE, GH) on the side cg and (QP, NM) on the side cd of the flat surface 1. The sides cg and cd designate the sides perpendicular to the direction of cutting of the strip 20, indicated by the arrow in the figure.

Following the cutting of the thumb indexes, an end part 20 of the said surface 1 is cut so as to obtain a strip 20 (IJKL) irreversibly detachable from the surface 1 (FIG. 3).

FIG. 4 then presents the cutting of two tongues 4 (UVWX and U′V′W′X′) on part of the strip 20 (IJKL). The cut is discontinuous along the lines (WX) and (W′X′), which corresponds to breaks in cuts as shown diagrammatically by the dotted lines in FIG. 4, which presents a strip 20 seen in front view. This discontinuity creates attachment points 401 enabling the tongue 4 to be connected to the strip 20. These attachment points 401 break when the tongue 4 is extracted from its housing 9/flap 3.

The cutting of the tongues 4 is followed by the gluing of the area 70 of the said internal part 12 on the strip 21 (see FIG. 5, which presents the strip 21 alone). The gluing then serves to fix the two strips to each other at the area 70.

The gluing is followed by the complete superimposition of the strip 20 on the internal part 12 (CFOR) of the strip 21 (see FIGS. 6 and 7), the strip 20 having two tongues 4, and then the fixing of the strip 20 to the strip 21.

When this fixing takes place, the glued area 20 will correspond at every point to the area WW′X′X (see FIG. 8a). Thus the points L and R, K and 0, I and C, J and F correspond to each other mutually. The thumb indexes DE and QP are hidden by the strip 20, as shown in the figure. FIG. 8b presents the superimposing of the strips 20, 21 in side view.

The following step is the fragrance coating on the parts 410 of the tongues 4 and on the areas 413 of the flap 3 (see FIG. 9). FIG. 9b is a side view of FIG. 9a.

FIG. 10 illustrates the depositing of glue 71 on the part CR or I1L1 of the strip 21. The depositing of glue is preferably made on the part I1L1.

The depositing of glue 71 is followed by the folding of the flap 3 over the strip 20 towards the inside of the surface 1 as indicated in FIG. 11a, so as to create a housing 9/flap 3. The depositing of glue and the folding make it possible to fix the flap 3/housing 9 to the strip 21 (see FIG. 11b). This housing 9 encloses two perfumed tongues 4 (see FIG. 12 illustrating the housing 9).

Finally, the strip 21 is folded (FIG. 13) in two superimposable parts ATBS and JKFB, along the line BS, as indicated in FIGS. 12 and 13, so as to obtain a product which opens like a book and which has the housing 9 enclosing a strip 20 provided with two perfumed tongues 4, a thumb index MN facilitating the gripping of the tongue 4 in order to extract it from its housing 9.

The article is then inserted in a magazine or insert. The user, when he wishes to access the perfume deposited on one of the tongues, then merely needs to pull the tongue 4 out of its housing (in the direction indicated in FIG. 13 by an arrow), so as to break the perfume microcapsules, which will release a fragrance.

Further Description of the Second Embodiment:

FIG. 14 describes a flat surface 1 provided with a strip 20 (IJKL) to be cut. The flat surface 1 is a paper support, which is to be cut along IJ.

FIG. 15 presents the lamination 50 of the strip 21 (ATLI) on its external face. The lamination reinforces the strip 21 and makes it impermeable.

FIG. 16 illustrates the cutting of the flat surface 1 so as to form two strips independent of each other, that is to say a strip 20 and a laminated strip 21.

After cutting the strips 20 and 21, the strip 20 is glued 60 over its entire internal surface (see FIG. 17a and the arrow indicating the internal direction), and is then folded in two parts 201, 202 superimposable at any point (see FIG. 17b) so that the two internal faces of the parts 201, 202 are glued 60 together, in order to form a strip 20 folded in two.

The gluing and folding are followed by the partial superimposition in an offset manner above an internal part 12 (I1L1Z1Z) of the strip 21 (see FIG. 18a where the area 2011 is not superimposable on the strip 21 and FIG. 18b in side view, which shows the offset between the strips 20 and 21).

The gluing, folding and superimposition steps are preferably simultaneous.

FIG. 19 illustrates simultaneously the gluing and folding of the strip 20 and the superimposition of the strip 20 on a part 12 of the laminated strip 21.

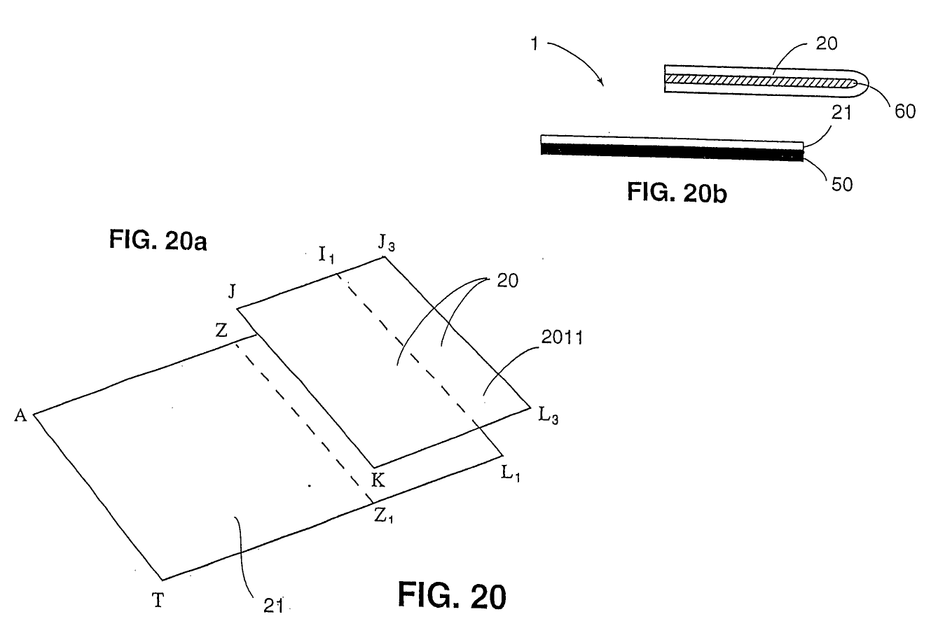

FIG. 20, composed of FIGS. 20a and 20b, presents the strip 20 (folded in two) and the laminated strip 21 at the end of the superimposition/folding and gluing operations.

FIG. 21 illustrates the cutting of a tongue 4 on a part of the strip 20. The cutting is discontinuous, as shown diagrammatically by the dotted lines in FIG. 21b. This discontinuity creates attachment points 401 enabling the tongue 4 to be connected to the strip 20. In FIG. 21a, it can be seen that the cutting of the tongue in accordance with the segments (TU) and (PQ) is made in the area 2011, which is offset with respect to the strip 21. These segments will subsequently serve for the formation of a stopper 19 integral with the tongue 4.

The cutting of the tongue is followed by a coating of fragrance on a part 410 of the tongue 4 (see FIG. 22a). The fragrance is preferably deposited in the form of microcapsules distributed in a dispersion (see FIG. 22b in side view).

The following operation is the gluing of the area 20 of the laminated strip 21 (see FIG. 23a, which presents the strip 21 alone). The gluing takes place over the entire internal surface of the strip 21, with the exception of two areas 42 and 43 which have substantially identical dimensions and are superimposable not only on each other but also superimposable on the tongue 4. These areas 42, 43 have a surface area substantially greater than that of the tongue 4, so that the tongue does not remain stuck to the strip 21 during the subsequent folding of the flap 3 over the said strip 20 comprising this tongue.

A person skilled in the art will know how to specify and adjust the dimensions of these areas 42 and 43 by means of a few routine tests.

The gluing of the area 70 is followed by the fixing of the strip 20 on the laminated strip 21, in an offset fashion as presented in FIGS. 23b and 23c, which creates a flap 3 (ATZZ1) integral with the strip 21. FIG. 23c depicts FIG. 23b in side view and in transverse section along the axis x.

According to FIG. 24, the fixing is followed by a folding of the flap 3 along the line (ZZ1) over the strip 20 folded in two parts 201, 202 stuck together. The folding is adapted so that the edge (AT) of the flap 3 comes to be placed under the segments TU and PQ of the tongue 4. This operation creates a housing 9/flap 3 which encloses a strip 20 provided with a perfumed tongue 4.

The last operation consists of cutting the contour of the housing 9 and of the tongue/stopper partly projecting 19 out of the housing 9. The cut is made along the segments MN, NO, QR, RS, ST, WV and WX (see FIG. 25a), taking the shape of a perfume bottle provided with a stopper. This stopper is integral with the tongue 4 and is formed by the cut along QR, ST, RS.

FIGS. 25b and 25c show the article obtained by the method according to the invention. This article comprises a housing 9/flap 3 enclosing a strip 2 provided with a perfumed tongue 4 and having a stopper 19 integral with the latter. The user can extract the tongue 4 out of its housing 9 by pulling on it at the stopper 19 in the direction indicated in the figure. The pulling causes the rubbing of the fragrance microcapsules against the inside of the housing 9/flap 3, which makes the microcapsules burst and releases the fragrance. The user can then approach the tongue 4, for example in order to smell the fragrance close to her nose or to rub it on her skin. This article can also be inserted in a magazine or insert.

Description of a Third Embodiment According to the Invention:

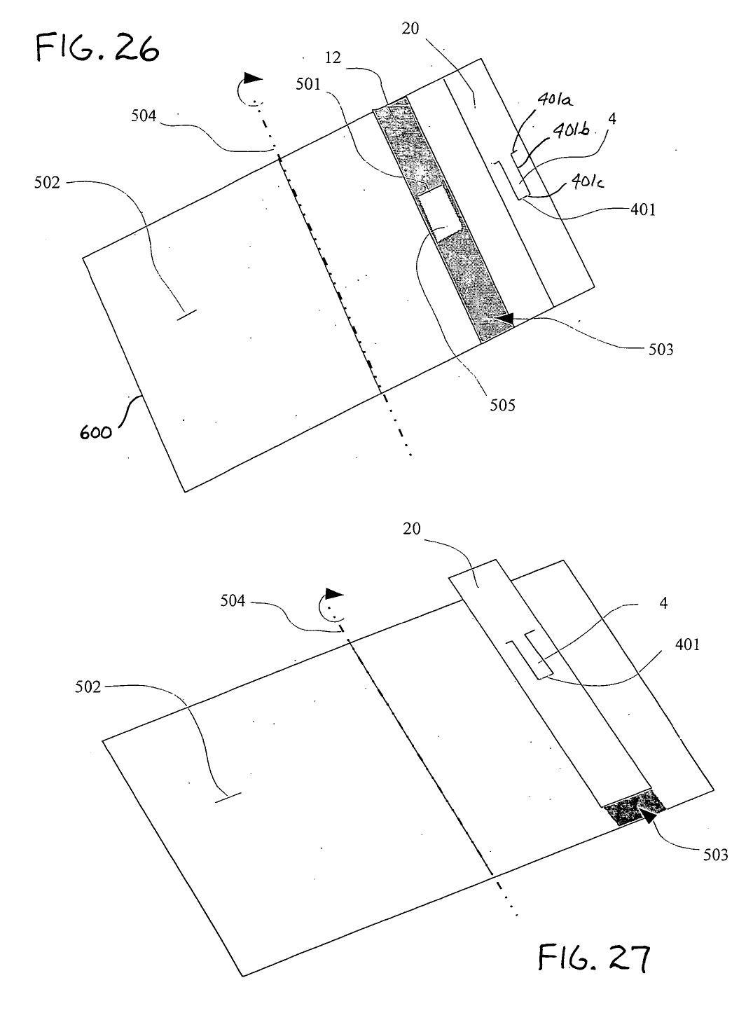

FIGS. 26 to 32 illustrate a third embodiment according to the present invention. This embodiment is similar to that disclosed and illustrated with reference to FIGS. 1 and 21 to 25. Starting out from a flat sheet 600, comprising a fold axis as indicated at 504, a tongue-shaped element 4 is made by perforation of a longitudinal strip 20 that is located along one side of the sheet, as shown in FIG. 26. The perforations 401 are such that the tongue 4 extends from two lines of perforation 401a located substantially perpendicular to the length of the strip, which two lines of perforation are then joined, one on each side respectively of strip 20, by a longitudinal perforation 401b made along the length of the strip 20. The two longitudinal perforations 401b are joined at their bottom by a further transverse perforation 401c, to form the tongue-shaped element 4.

Spaced apart from the strip 20 is another area of the sheet 600 that defines a further strip 12, in which a transverse slit 501 has been made. By “transverse”, it is to be understood that the slit is made substantially orthogonally or perpendicular to the length of strips 12 and 20. The slit 501 extends from near one edge of strip 12 to near the opposite edge of said strip 12 and is located at a height along strip 12 that substantially corresponds to the height of the two lines of perforation 401a that extend substantially perpendicular to strip 20. The area that defines strip 12 is covered with a layer of adhesive, indicated by the general reference 503, apart from a central zone 505 that contains no adhesive. This central zone covers approximately a surface area corresponding to that formed by the tongue 4 of strip 20, as will become clear in the following continued description of the embodiment.

The flat sheet 600 further comprises another slit 502, extending substantially perpendicular to the length of strip 20, and located at substantially the same height as the two lines of perforation 401a that extend substantially perpendicular to strip 20.

Referring next to FIG. 27, the strip 20 is cut off and laid over the strip 12, such that strip 20 adheres to strip 12 via the adhesive 503, except in the area 505. The perforations 401a that define the feet of the tongue-shaped element are positioned substantially directly over the slit 501 in such a way that they coincide.

A quantity of perfume, indicated generally by the reference 506, is then loaded onto the tongue element 4, as shown in FIG. 28. The perfume can be applied directly, or is generally applied as a slurry composition well known to those skilled in the art. Other means of providing a perfume or fragrance composition are also well known, such as microencapsulation of a perfume of or fragrance, that will release the fragrance, for example on friction contact.

In the next step, a layer of adhesive 507 is applied to the sheet in an area to the left (when viewing FIG. 29) of the fold axis 504. The adhesive 507 is applied substantially over the whole of this area, except for a central zone 508, that corresponds to an equivalent surface area of zone 505.

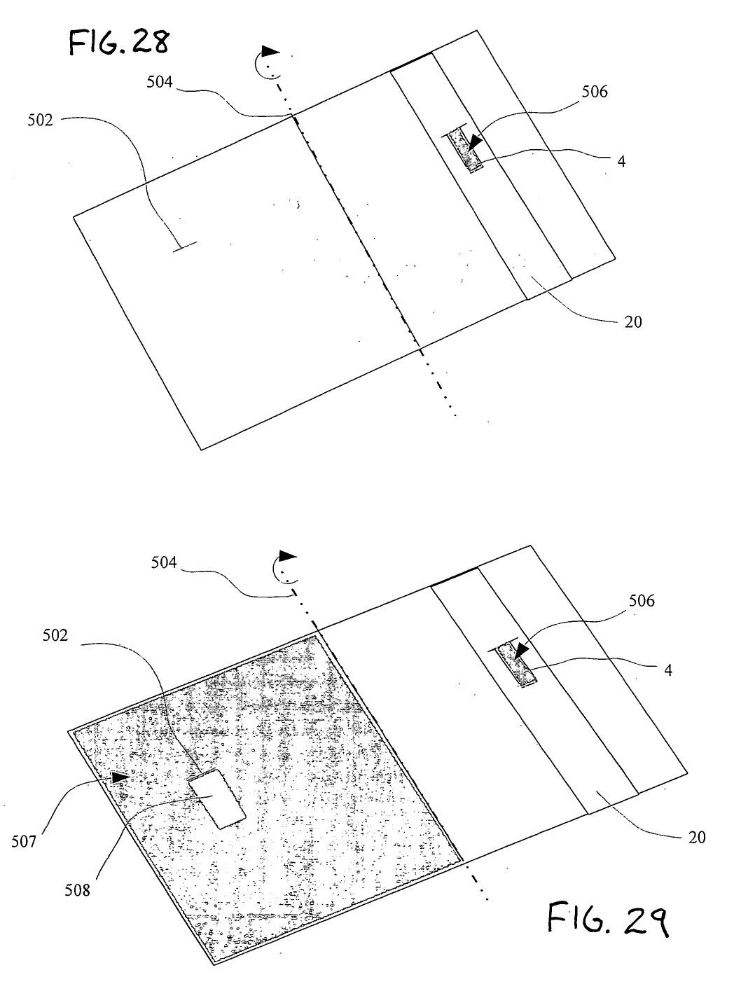

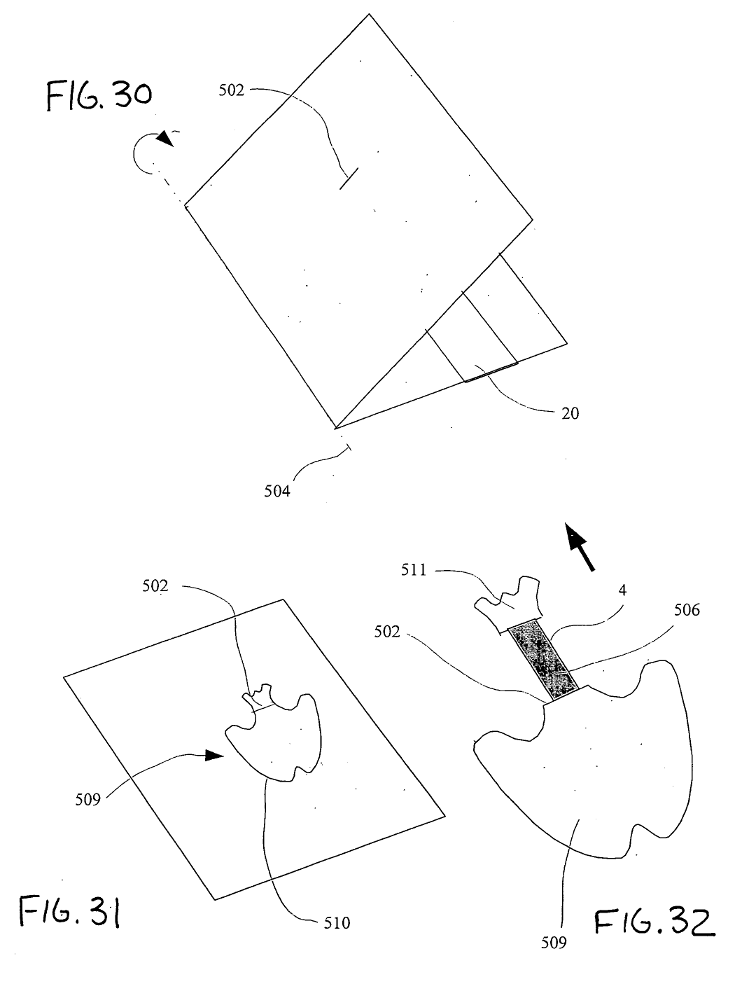

Referring next to FIG. 30, once the adhesive 507 has been applied, the sheet is folded about fold axis 504 to cover and adhere to the rest of the sheet. This operation puts slit 502 above slit 501 and effectively covers the tongue element 40 of strip 20.

A shape 509 is then formed on the folded sheet about the slit 502, as shown in FIG. 31. This shape can be for example, a bottle or vial shape, or any form of object that it is desired to produce on the paper. The shape 509 is made by perforating the sheet with a contour perforation 510 such that the shape is still held by the sheet, and forms an integral part thereof, but can easily be pushed out by a user, using just finger or hand pressure to separate the shape from the sheet.

As mentioned above, the shape 509 can be retained on the sheet and inserted into a magazine for example, as an advertisement. The reader can then push out the shape 509 by hand, by separating the perforated shape 509 from the sheet. In the example shown in FIGS. 31 and 32, the shape is a small bottle or vial, for example, a perfume bottle. The tongue element 4, which is sandwiched between the folded sheet and glued by the adhesive at a level above the two lines of perforation located substantially perpendicular to the length of the strip 20, comprises a sample 506 of the perfume corresponding to the brand or make of perfume being advertised or marketed. The shape 509 once separated now presents a grip or prehensile element 511, on which a traction or pulling force can be exerted. This traction or pulling force will be exerted longitudinally, in the same direction as the longitudinal perforations of the tongue 4 (see arrow in FIG. 32). When traction is exerted, the perforations of the tongue element 4 are torn and the tongue element 4 can be withdrawn from shape 509 via prehensile element 511. In addition, this movement exerts a frictional or rubbing force, due to the presence of the non-adhered zone 508 of the sheet layer that superposes strip 20, on the tongue element containing the layer 506 of deposited perfume or fragrance material, causing said perfume or fragrance to be freed, and enabling the reader to smell the perfume or fragrance sample from the tongue element 4.

The invention described herein also covers all the embodiments and applications which will be directly accessible to a person skilled in the art on reading the present application, from his own knowledge. For example, the step of cutting an end part 20 of the flat surface 1 is preceded by a color and text printing step on the flat surface 1.

While there has been described what is presently believed to be the preferred embodiments of the invention, those skilled in the art will realize that various changes and modifications may be made to the invention without departing from the spirit of the invention, and it is intended to claim all such changes and modifications as fall within the scope of the invention.

What is claimed is:

1. A method of manufacturing a promotional article, such as for advertising, product sampling or information supplying, the method comprising the steps of:
forming a fixing portion and a tongue portion on a strip, said tongue portion being at least partially detachable from said fixing portion;
fixing said fixing portion of said strip to a flat surface of a substrate;
forming a substantially flat housing by folding a flap portion of said substrate over said strip to substantially enclose said strip,
wherein said tongue portion of said strip can be at least partially removed from within said housing by pulling said tongue portion from said fixing portion.

2. A method as set forth in claim 1, further comprising the step of initially cutting off a portion of said substrate to form said strip.

3. A method as set forth in claim 1, wherein said strip is substantially rectangular.

4. A method as set forth in claim 1, wherein said fixing portion of said strip is glued to said flat surface of said substrate during said fixing step.

5. A method as set forth in claim 1, further comprising the step of forming a perforation in said strip between said fixing portion and said tongue portion, said perforation allowing said tongue portion to be at least partially detachable from said fixing portion.

6. A method as set forth in claim 1, wherein said tongue portion of said strip can be at least partially removed from within said housing by pulling said tongue portion in a longitudinal direction.

7. A method as set forth in claim 1, further comprising the step of applying a fragrance to at least a portion of said strip tongue portion.

8. A method as set forth in claim 7, wherein said fragrance is applied to said tongue portion by microencapsulation.

9. A method as set forth in claim 1, further comprising the step of applying a fragrance to an inner surface of said housing formed by said substrate.

10. A method as set forth in claim 1, wherein said strip is formed with two tongue portions on opposite sides of said fixing portion, wherein said two tongue portions can be at least partially removed from within opposite ends of said housing by pulling said tongue portions from said fixing portion.

11. A method as set forth in claim 1, wherein said step of forming said substantially flat housing further includes the step of adhering said flap portion to said substrate after folding said flap portion.

12. A method as set forth in claim 1, further comprising the step of folding a second flap portion of said substrate over said housing to cover said housing with said second flap portion.

13. A method as set forth in claim 1, further comprising the step of cutting out at least one lateral part of said substrate, said lateral part providing access to said tongue portion within said housing.

14. A method as set forth in claim 13, wherein said lateral part has a shape selected from the group consisting of a circle, a square, a hexagon, a semi-circle, a heart, a club and a spade.

15. A method as set forth in claim 1, further comprising the step of applying a barrier material to an inner surface of said housing formed by said substrate, said barrier material substantially enclosing said strip when said housing is formed.

16. A method as set forth in claim 1, wherein at least a portion of said strip tongue portion extends outwardly from said housing.

17. A method as set forth in claim 16, further comprising the step of cutting the housing and said portion of said strip tongue portion extending outwardly from said housing to a desired shape.

18. A method as set forth in claim 17, wherein the housing is cut in the shape of a perfume bottle and said portion of said strip tongue portion extending outwardly from said housing is cut in the shape of a perfume bottle stopper.

19. A method as set forth in claim 1, wherein at least one of said strip and said substrate has a laminated structure.

20. A method as set forth in claim 1, further comprising the step of cutting a desired shape into said folded substantially flat housing, said shape having a grip portion and a body portion, said grip portion being separable from said body portion for at least partially removing said tongue portion of said strip from within said body portion.

21. A method as set forth in claim 20, wherein said grip portion of said housing is connected to said tongue portion of said strip.

22. A method as set forth in claim 21, wherein said body portion of said shape is cut in the shape of a perfume bottle and said grip portion of said shape is cut in the shape of a perfume bottle stopper.

23. A method as set forth in claim 21, wherein said cutting of said desired shape into said housing comprises the step of perforating said housing, wherein said shape forms an integral part of said housing, but can be detachable therefrom.

24. A promotional article, such as for advertising, product sampling or information supplying, comprising:
a support substrate having a substantially flat housing formed thereon by folding over a flap portion of said support substrate; and
a strip substantially enclosed within said housing, said strip having a fixing portion and a tongue portion, said tongue portion being at least partially detachable from said fixing portion and said fixing portion being fixed to an inner surface of said housing,
wherein said tongue portion of said strip can be at least partially removed from within said housing by pulling said tongue portion from said fixing portion.

25. A promotional article as set forth in claim 24, wherein said strip is formed by initially cutting off a portion of said support substrate.

26. A promotional article as set forth in claim 25, wherein said strip is substantially rectangular.

27. A promotional article as set forth in claim 24, wherein said fixing portion of said strip is glued to said inner surface of said housing.

28. A promotional article as set forth in claim 24, wherein said strip includes a perforation between said fixing portion and said tongue portion, said perforation allowing said tongue portion to be at least partially detachable from said fixing portion.

29. A promotional article as set forth in claim 24, wherein said tongue portion of said strip can be at least partially removed from within said housing by pulling said tongue portion in a longitudinal direction.

30. A promotional article as set forth in claim 24, wherein said tongue portion of said strip includes a fragrance applied thereon.

31. A promotional article as set forth in claim 30, wherein said fragrance is applied to said tongue portion by microencapsulation.

32. A promotional article as set forth in claim 24, wherein said inner surface of said housing includes a fragrance applied thereon.

33. A promotional article as set forth in claim 24, wherein said strip includes two tongue portions formed on opposite sides of said fixing portion, wherein said two tongue portions can be at least partially removed from within opposite ends of said housing by pulling said tongue portions from said fixing portion.

34. A promotional article as set forth in claim 24, wherein said flap portion of said support substrate is adhered to said substrate to form said housing.

35. A promotional article as set forth in claim 24, wherein said support substrate includes a second flap portion folded over said housing to cover said housing.

36. A promotional article as set forth in claim 24, wherein said support substrate includes at least one lateral cut-out formed therein, said lateral cut-out providing access to said tongue portion within said housing.

37. A promotional article as set forth in claim 36, wherein said lateral cut-out has a shape selected from the group consisting of a circle, a square, a hexagon, semi-circle, a heart, a club and a spade.

38. A promotional article as set forth in claim 24, further comprising a barrier material disposed on said inner surface of said housing, said barrier material substantially enclosing said strip.

39. A promotional article as set forth in claim 24, wherein at least a portion of said strip tongue portion extends outwardly from said housing.

40. A promotional article as set forth in claim 39, wherein said housing is cut in the shape of a perfume bottle and said portion of said strip tongue portion extending outwardly from said housing is cut in the shape of a perfume bottle stopper.

41. A promotional article as set forth in claim 29, wherein at least one of said strip and said substrate has a laminated structure.

42. A promotional article, such as for advertising, product sampling or information supplying comprising:
a substantially flat housing having an interior pocket defined therein;
a strip substantially enclosed within said pocket of said housing, said strip having a fixing portion and a tongue portion, said tongue portion being at least partially detachable from said fixing portion and said fixing portion being fixed to an inner surface of said housing pocket,
wherein said tongue portion of said strip can be at least partially removed from said pocket within said housing by pulling said tongue portion from said fixing portion.

43. A promotional article as defined in claim 42, wherein said substantially flat housing comprises a substrate folded over upon itself to substantially enclose said strip.

44. A promotional article as defined in claim 42, wherein said strip includes a perforation between said fixing portion and said tongue portion for allowing said tongue portion to be at least partially detachable from said fixing portion.

45. A promotional article as defined in claim 42, wherein said tongue portion of said strip includes a fragrance applied thereon.

46. A promotional article as defined in claim 42, wherein at least a portion of said strip extends outwardly from said housing.

47. A promotional article as defined in claim 46, wherein said housing is in the shape of a perfume bottle and said portion of said strip extending outwardly from said housing is in the shape of a perfume bottle stopper.

48. A promotional article as defined in claim 42, wherein said housing includes a grip portion and a body portion, said body portion defining said interior pocket therein and said grip portion being separable from said body portion for at least partially removing said tongue portion of said strip from said body portion pocket.

49. A promotional article as defined in claim 48, wherein said grip portion of said housing is connected to said tongue portion of said strip.

50. A promotional article as defined in claim 47, wherein said body portion has the shape of a perfume bottle and said grip portion has the shape of a perfume bottle stopper.
